(19) United States
(12) Patent Application Publication
(10) Pub. No.: US 2016/0095336 A1
(43) Pub. Date: Apr. 7, 2016

(54) METHOD FOR CREATING A DECORATION ON A LAYER OF DOUGH FOR MAKING PASTA

(71) Applicant: PASTIFICIO RANA S.P.A., San Giovanni Lupatoto (VR) (IT)

(72) Inventor: Giovanni RANA, San Giovanni Lupatoto (IT)

(21) Appl. No.: 14/595,965

(22) Filed: Jan. 13, 2015

(30) Foreign Application Priority Data
Oct. 2, 2014 (IT) VR2014A000238

(51) Int. Cl. A23L 1/16; A23L 1/00

(52) U.S. Cl. CPC A23L 1/16; A23L 1/0067; A23L 1/0073; A23V 2002/00

(57) ABSTRACT

Described is an invention which applies to the food products sector, in particular to the pasta sector, and it relates to a method for creating a decoration on a layer of dough for making pasta, comprising the following steps: preparing a layer of dough; calibrating the thickness of the layer to obtain a predetermined thickness value; positioning the layer between a mould having at least one recess shaped according to a predetermined ornamental pattern and a contact element, the positioning step being performed after the calibrating; moulding at least one surface of the layer positioned between the mould and the contact element. More specifically, the moulding step is performed by permanently deforming the layer of dough by applying a pressure between the mould and the contact element in such a way that, due to the effect of the pressure applied, portions of dough of the layer penetrate in the recess without creating discontinuities on the surface of the layer, that is to say, without cutting or perforating the layer.

This invention relates to a method for creating a decoration on a layer of dough for making pasta.

This invention applies to the food products sector, in particular to that of pasta—yet more in particular to the fresh egg pasta sector—and relates to a method for obtaining a decorated dough from which pasta is made, for example tagliatelle, lasagne, tortelli, ravioli, tortellini and other filled and unfilled pasta.

As is known, the operators in the food industry are constantly in search of new products and production methods which are able to satisfy the increasingly sophisticated demands of consumers, in terms of product storage life, nutritious quality, organoleptic properties, and even with regard to the outside appearance of the product.

With reference to the filled pasta sector, in particular of fresh pasta, the product must have several characteristics in order to reach the levels of quality required by the market.

Firstly, the pasta must be able to quickly absorb the water during cooking, in such a way as to reduce the preparation time. Secondly, the pasta must be able to absorb large quantities of sauce during the flavouring step, to allow for the preparation of various types of recipes. Moreover, the pasta must be able to maintain the so-called “al dente” nature, even if subjected to a pre-cooking step needed to accelerate the actual cooking step; pre-cooking is usually carried out in the large catering chains in order to speed up the time for preparing the meals, especially during very busy periods. In light of this, the finish and the final consistency of the pasta are extremely important aspects for the consumer, especially for the fresh pasta sector.

A further need is to satisfy the requirements of the consumers with regard to the external appearance of the food products, in particular in the sectors of pasta and oven-made products, such as, for example, cakes, bread, pastry products and the like. hi this regard, in the pasta sector, different forms of pasta have been made for some time purely for decorative purposes.

With particular reference to the outside appearance of food products, the operators in the sector are constantly in search of new production methods which are able to provide aesthetically innovative products. In the pasta sector, the need has been particularly felt to develop production methods for making pasta provided with decorative elements, which are able—for example—to encourage consumption by children or to support new marketing initiatives in the catering and fast-food sectors.

From the point of view of production methods, an essential aspect is the possibility of automating the production method in order to guarantee, on the one hand, the maintaining of certain quality standards regardless of the workers used and, on the other hand, to maximise productivity.

In the oven-made and cake products sector, there are production methods which generally have the following steps:
preparing a dough;
cutting the dough with a mould having a predetermined shape, for isolating and shaping a predetermined portion of dough.
removing the isolated and shaped portion of dough from the mould;
baking, typically in an oven, the isolated and shaped portion, to fix the shape obtained by moulding.

A production method of the type described above is shown, for example, in U.S. Pat. No. 4,789,555 and U.S. Pat. No. 8,230,604.

A variant embodiment of the production method described above comprises perforating and cutting the dough with a first mould which is able to isolate a portion of dough and give it a substantially two-dimensional shape; next, the portion is cooked in the oven inside a second mould which is able to give it a three-dimensional shape, as shown in U.S. Pat. No. 5,437,829.

With specific reference to the pasta sector, in particular to that of fresh pasta, there are prior art production methods which have a step for extruding the dough through plates, typically made of bronze, having a predetermined shape; the dough, during the forced passage through the plates, is shaped in such a way as to adopt typically three-dimensional shapes. Immediately after the extruding step, there is a cutting step, generally using a blade, for dividing the dough into portions of predetermined dimensions, depending on the desired size of pasta.

A production method of the type described above is shown, for example, in patent document EP 2737800.

With particular reference to the production of tagliatelle, lasagne, tortelli, ravioli, tortellini or filled pasta in general, there is firstly a step of laminating the dough for forming the so-called sheet or layer of dough, which is then cut longitudinally to form tagliatelle, lasagne and other unfilled pasta. On the other hand, in order to produce tortelli, ravioli, tortellini or other filled pasta, several doses of filling are placed on a first layer of pasta, which is subsequently wound on itself or coupled and superposed on a second layer of pasta to form a sheet of two layers, between which the filling is located in certain zones; subsequently, the sheet of two layers is re-cut at the zones containing the filling, to obtain tortelli, ravioli, tortellini and the like.

A method for making ravioli and the like is shown, for example, in U.S. Pat. No. 3,373,702.

According to the state of the art briefly described above, the prior art production methods allow pasta to be made having a wide range of final shapes, for example tagliatelle, maccheroni, spaghetti, tortelli, ravioli, tortellini, etc., but they do not allow the dough from which the pasta is made be decorated directly. More specifically, there are no methods which are able to create a finish with a decorative pattern directly on the surface of the layer of dough, that is to say, there are no methods which are able to decorate the surface of the dough with ornamental patterns, without cutting or perforating the dough to obtain individual forms, or shapes, of pasta.

Currently, in order to satisfy the demands of the consumers in terms of an attractive appearance of the pasta, the layer of dough is shaped to obtain individual forms of pasta, but is not known to provide a decorated dough intended for subsequent shaping for making individual sizes of pasta.

Disadvantageously, therefore, since there is not a prior art method which allows decorative patterns to be made on the surface of the layer of dough, any marketing initiatives which involve an entire range of pasta regardless of the final shape can only be achieved by means of the packaging of the product, since it is the only element capable of standardizing the different shapes of pasta from an appearance point of view.

The prior art methods are not free of drawbacks. Firstly, the needs of fast cooking and/or absorption of sauces limit the shapes of pasta which can be used and, therefore, the patterns which can be obtained. Secondly, some shapes of pasta deform following a pre-cooking step in water, losing the so-called “tooth” nature and are therefore unsuitable for the catering sector, but only suitable (at the most) for domestic use.

Disadvantageously, making decorative shapes for the pasta is complicated, since it is necessary to know precisely and in advance where the filling will be positioned, in such a way as to not adversely affect the condition of the final product during the shaping step to obtain the desired decorative appearance.

In this context, the technical purpose which forms the basis of this invention is to provide a method for creating a decoration on a layer of dough for making pasta, which overcomes the above-mentioned drawbacks of the prior art. More specifically, the aim of this invention is to provide a method which allows the sheet to be used for making the various shapes of pasta, for example tagliatelle, lasagne, tortelli, ravioli, tortellini and, more in general, filled and unfilled pasta, to be decorated directly.

A further aim of this invention is to provide a method for creating a decoration on a layer of dough for making pasta which is able to make decorative patterns on the sheet, without adversely affecting the integrity, that is to say, without cutting or perforating.

Another aim of this invention is to provide a method for creating a decoration on a layer of dough for making pasta which allows permanent decorative patterns to be made, that is to say, which are able to remain visible even after a step for cooking and/or pre-cooking the pasta in water.

Another aim of this invention is to provide a method for creating a decoration on a layer of dough for making pasta which can be automated, to guarantee a high productivity.

Another aim of this invention is to provide a method for creating a decoration on a layer of dough for making pasta which allows a sheet to be made which reduces the absorption of water during the step for cooking and/or precooking, to allow the pasta to maintain the so-called “al dente” nature.

The technical purpose and aims specified are substantially achieved by a method for creating a decoration on a layer of dough for making pasta, comprising the technical features described in one or more of the appended claims. The dependent claims correspond to further embodiments of a method according to this invention.

Further features and advantages of this invention are more apparent in the description below, with reference to a preferred but non-limiting embodiment of a method for creating a decoration on a layer of dough for making pasta.

According to the invention, a method for creating a decoration on a layer of dough for making pasta comprises the following steps:
preparing a layer of dough;
calibrating the thickness of the layer to obtain a predetermined thickness;
positioning the layer between a mould having at least one recess shaped according to a predetermined ornamental pattern and a contact element; more specifically, the positioning step is performed after the calibrating step;
moulding at least one surface of the layer positioned between the mould and the contact element.

More specifically, the moulding step is performed by permanently deforming the layer of dough by applying a pressure between the mould and the contact element in such a way that, due to the effect of the pressure applied, portions of dough of the layer penetrate in the recess without creating discontinuities on the surface of the layer, that is to say, without cutting or perforating the layer. Advantageously, unlike the prior art, a method according to this invention allows the creation of a finish with a decorative pattern directly on the surface of the layer of dough, that is to say, it allows the surface of the dough to be decorated with ornamental patterns, without cutting or perforating the dough to obtain individual shapes of pasta. In effect, only in a second stage is the decorated dough worked to form pasta with predetermined shapes. With regard to that, the subsequent working may be limited to a simple step of cutting the dough, for example for making tagliatelle, since the layer has itself decorative patterns and does not require further shaping or working to give an appearance to the pasta.

According to a first variant embodiment of the method, the moulding step is performed by applying a pressure on portions of dough of the layer adjacent to portions of dough of the layer facing the recess of the mould in such a way that, due to the pressure applied, the portions of dough facing the recess are forced to penetrate inside it, so that the layer is neither perforated nor cut. In other words, the pressure applied to the adjacent portions causes a deformation of the layer of dough such that the portions of dough facing the recess rise inside the recess. According to this first variant embodiment, the pressure is preferably applied by portions of the mould free of a recess, which press the layer of dough against the contact element. Yet more preferably, the moulding step is performed by laminating by means of a pair of rollers: in particular, a first of the rollers is provided, on the surface, with at least one recess, whilst a second of the rollers has a substantially smooth surface.

According to a second variant embodiment of the method, the contact element comprises a counter-mould and the moulding step comprises the following sub-steps:
positioning the layer between the mould, having a recess which reproduces an ornamental pattern, and the counter-mould;
applying a pressure between the mould and the counter-mould in such a way that portions of dough facing the recess are pushed into it by the counter-mould, so that the layer of dough is permanently deformed without being perforated or cut. According to this second variant embodiment, the moulding step is performed by laminating by means of a pair of rollers: in particular, a first of the rollers is provided, on the surface, with at least one recess, whilst a second of the rollers is provided, on the surface, with at least one protrusion shaped to match the corresponding recess of the first roller, in such a way as to define a counter-mould.

Advantageously, in both the embodiments described, the moulding step performed by laminating using rollers guarantees a high productivity.

Preferably, the pressure applied is approximately between 20 N/mm² (that is to say, approx. 20 MPa [megaPascal]) and approx. 50 N/mm² (that is to say, approx. 50 MPa [megaPascal]). Advantageously, such a pressure value guarantees the creation of the decoration, avoiding perforating or cutting the dough, which adversely affect an optimum absorption of water and dressing the pasta which will be subsequently produced.

In both the embodiments described above, the rollers are positioned facing each other and at a predetermined distance from each other.

Preferably, the method comprises a step for adjusting the distance between the ropers, in such a way as to vary the pressure applied by the rollers on the layer of dough during the moulding step. In this way, the moulding step by laminating may be performed on layers of dough having, after the calibrating step, a thickness of between approximately 0.4 mm and approximately 1.5 mm.

Preferably, the recess of the mould has a depth of between approximately 0.25 mm and approximately 0.30 mm, yet more preferably a depth of approximately 0.27 mm.

Preferably, the thickness of the decoration obtained by the mould is between approximately 18% and 67% of the total thickness of the layer of dough. Advantageously, the combination of the above-mentioned values of:

to) thickness of the layer (after the calibrating step);

b) thickness of the decoration in proportion to the thickness of the layer; and

c) thickness of the recess of the mould,

allows a convenient deformation of the sheet, whilst guaranteeing suitable plasticity to the sheet, in such a way as to ensure that the decoration is maintained even during the steps for pre-cooking and cooking the pasta in water.

According to the invention, the method also comprises a step for cutting the dough to form longitudinal strips of dough of predetermined width, for making tagliatelle and/or lasagne. Alternatively to the step of cutting the dough, the method comprises the steps of:
placing at least one dose of filling on at least a first zone of a first layer of dough;
winding the first layer on itself to completely cover the dose or, alternatively, coupling and superposing a second layer of dough, to obtain in both cases two layers between which the filling is interposed;
adhering together the two layers;
cutting the two layers into portions at the zones containing the filling, to obtain filled pasta. In more detail, the adhering step is performed at portions positioned at the perimeter of the dose of filling, so that the decoration of the layer at the filling is not modified. Advantageously, the use of a dough decorated according to this invention allows the production in a simple manner of filled pasta having a decorative pattern, since it is not necessary to know precisely and in advance where the filling will be positioned; in effect, unlike the prior art, in order to obtain a decorative pattern no modelling of the dough is required, which is potentially harmful for the quality of the product, if the modelling should unexpectedly result in the manipulation of the zone containing the filling. According to the invention, the decorative pattern is obtained by a surface finishing made directly on the dough.

This invention also relates to a dough obtained by the method described above, as well as a pasta obtained from the dough.

1. A method for creating a decoration on a layer of dough for raking pasta, comprising the following steps:
preparing a layer of dough;
calibrating the thickness of the layer to obtain a predetermined thickness;
positioning the layer between a mould having at least one recess shaped according to a predetermined ornamental pattern and a contact element, the positioning step being performed after the calibrating step;
moulding at least one surface of the layer positioned between the mould and the contact element,
characterised in that the moulding step is performed by permanently deforming the layer of dough by applying a pressure between the mould and the contact element in such a way that, due to the effect of the pressure applied, portions of dough of the layer penetrate in the recess without creating discontinuities on the surface of the layer, that is to say, without cutting or perforating the layer.

2. The method according to claim 1, wherein the moulding step is performed by applying a pressure on portions of dough of the layer adjacent to portions of dough of the layer facing the recess of the mould in such a way that, due to the pressure applied, the portions of dough facing the recess are forced to penetrate inside it, so that the layer is neither perforated nor cut.

3. The method according to claim 1, wherein the contact element comprises a counter-mould.

4. The method according to claim 3, wherein the moulding step comprises the following sub-steps:
positioning the layer between the mould, having a recess which reproduces an ornamental pattern, and the counter-mould;
applying a pressure between the mould and the counter-mould in such a way that portions of dough facing the recess are pushed into it by the counter-mould, so that the layer of dough is permanently deformed without being perforated or cut.

5. The method according to claim 1, wherein the recess has a depth of between approximately 0.25 mm and approximately 0.30 mm, preferably approximately 0.27 mm.

6. The method according to claim 1, wherein the pressure applied is between approximately 20 MPa and approximately 50 MPa.

7. The method according to claim 1, wherein the thickness of the layer after the calibrating step is between approximately 0.4 mm and approximately 1.5 mm.

8. The method according to claim 1, wherein the moulding step is performed by laminating by means of a pair of rollers, at least a first of the rollers comprising at least one recess on the surface.

9. The method according to claim 8, wherein a second of the rollers is provided on the surface with at least one protrusion shaped to match a corresponding recess of the first roller to form a counter-mould.

10. The method according to claim 8, wherein the rollers are positioned facing each other and at a predetermined distance from each other.

11. The method according to any of claim 8, comprising a step for adjusting the distance between the rollers for varying the pressure applied by the rollers on the layer of dough during the moulding step.

12. The method according to claim 1, wherein the thickness of the decoration obtained by the mould is between approximately 18% and 67% of the total thickness of the layer of dough.

13. The method according to claim 1, wherein the calibrating step is performed by laminating by means of a pair of laminating rollers.

14. The method according to claim 1, also comprising a step for cutting the dough to form longitudinal strips of dough of predetermined width for forming tagliatelle and/or lasagne.

15. The method according to claim 1, also comprising the steps of:
placing at least one dose of filling on at least a first zone of a first layer of dough;
winding the first layer on itself to completely cover the dose or, alternatively, coupling and superposing a second layer of dough, to obtain in both cases two layers between which the filling is interposed;
adhering together the two layers;
cutting the two layers into portions at he zones containing the filling, to obtain filled pasta,
the adhering step being performed at portions positioned at the perimeter of the dose of filling, so that the decoration of the layer at the filling is not modified.

16. Dough obtained by a method according to claim 1.

17. Pasta obtained from a dough according to claim 16.
